(19) United States
(12) Patent Application Publication
(10) Pub. No.: US 2026/0124959 A1
(43) Pub. Date: May 7, 2026

(54) VEHICLE

(71) Applicant: TOYOTA JIDOSHA KABUSHIKI KAISHA, Toyota-shi (JP)

(72) Inventor: Masashi KOBAYASHI, Toyota-shi (JP)

(73) Assignee: TOYOTA JIDOSHA KABUSHIKI KAISHA, Toyota-shi (JP)

(21) Appl. No.: 19/280,779

(22) Filed: Jul. 25, 2025

(30) Foreign Application Priority Data
Nov. 6, 2024 (JP) 2024-194221

(51) Int. Cl. B60L 58/26; B60L 53/62; B60L 58/13; G01C 21/36; H01M 10/46; H01M 10/48; H01M 10/613; H01M 10/625; H01M 10/633; H01M 10/6567

(52) U.S. Cl. CPC B60L 58/26; B60L 53/62; B60L 58/13; G01C 21/3697; H01M 10/46; H01M 10/486; H01M 10/613; H01M 10/625; H01M 10/633; H01M 10/6567; H01M 2220/20

(57) ABSTRACT

A vehicle that can be charged by connecting to an external charging device includes a navigation system in which a destination of the vehicle is set, a battery that stores electric power that is supplied from the external charging device, a cooling device that cools the battery, and an electronic control unit (ECU) that controls the cooling device. When the external charging device is set as the destination in the navigation system, the ECU acquires a maximum current of the external charging device from the navigation system, calculates a prediction value regarding what the SOC of the battery will be when the vehicle reaches the destination, based on navigation information from the navigation system, and when the maximum current exceeds a current threshold value and also the predicted value is equal to or less than a first SOC threshold value, operates the cooling device before the vehicle reaches the destination.

### CROSS-REFERENCE TO RELATED APPLICATION

This application claims priority to Japanese Patent Application No. 2024-194221 filed on Nov. 6, 2024. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

Japanese Unexamined Patent Application Publication No. 2010-166676 (JP 2010-166676 A) discloses a battery electric vehicle that cools a battery (power storage device) when a vehicle is near a destination, thereby suppressing temperature of the battery from becoming high when the battery is charged at the destination.

### SUMMARY

Generally, when a vehicle is connected to an external charging device to charge a power storage device that is installed in the vehicle, charging current is limited when temperature of the power storage device becomes high, in order to suppress deterioration of the power storage device. When the charging current is limited, charging time will become prolonged. Accordingly, cooling the power storage device when the vehicle nears the destination may enable the charging time to be shortened. However, when the temperature of the power storage device is not expected to become hot when the power storage device is being charged, cooling the power storage device may result in the temperature of the power storage device becoming lower than a temperature that is suitable for charging, which may actually lengthen the charging time.

An object of the present disclosure is to shorten the charging time of a power storage device.

(1) A vehicle according to an aspect of the present disclosure is configured to be chargeable by connecting to an external charging device. The vehicle includes a navigation system in which a destination of the vehicle is set, a power storage device that stores electric power that is supplied from the external charging device, a cooling device that cools the power storage device, and a control device that controls the cooling device. When the external charging device is set as the destination in the navigation system, the control device acquires a maximum current of the external charging device from the navigation system, calculates a prediction value of what a state of charge (SOC) of the power storage device will be when the vehicle reaches the destination, based on navigation information from the navigation system, and when the maximum current exceeds a current threshold value and also the prediction value is equal to or less than a first SOC threshold value, operates the cooling device before the vehicle reaches the destination.

(2) In the vehicle according to (1), when the maximum current does not exceed the current threshold value, the control device does not operate the cooling device before the vehicle reaches the destination.

(3) The vehicle according to (2) further includes a temperature sensor that detects a temperature of the power storage device. In a case in which the external charging device is set as the destination in the navigation system, when the maximum current exceeds the current threshold value and also the prediction value is equal to or less than the first SOC threshold value, the control device sets a first cooling start temperature such that the higher the maximum current is and also the lower the prediction value is, the lower the first cooling start temperature is set to be, and operates the cooling device in accordance with the temperature of the power storage device reaching the first cooling start temperature.

(4) In the vehicle according to (3), when the external charging device is set as the destination in the navigation system, and also the maximum current exceeds the current threshold value, the control device sets the first cooling start temperature such that, when the prediction value is equal to or lower than the first SOC threshold value, the greater the maximum current is and also the lower the predicted value is, the lower the first cooling start temperature is set to be, and operates the cooling device in accordance with the temperature reaching the first cooling start temperature, sets a second cooling start temperature such that, when the prediction value exceeds the first SOC threshold value but is equal to or lower than a second SOC threshold value that is higher than the first SOC threshold value, the greater the maximum current is and also the lower the prediction value is, the lower the second cooling start temperature that is higher than the first cooling start temperature is set to be, and operates the cooling device in accordance with the temperature reaching the second cooling start temperature, and recalculates the prediction value when the prediction value exceeds the second SOC threshold value, and the prediction value that is recalculated is compared with the first SOC threshold value or the second SOC threshold value to determine whether operation of the cooling device is necessary.

(5) In the vehicle according to (4), the control device sets each of the first cooling start temperature and the second cooling start temperature based on a life requirement of the power storage device.

According to the present disclosure, the charging time of the power storage device can be shortened.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a vehicle according to an embodiment of the present disclosure;

FIG. 2 is a flowchart showing processing procedures of pre-cooling processing that is executed by an ECU 40;

FIG. 3 is a graph showing a relation between a SOC of a battery 10 and charging current flowing through the battery 10, for each maximum current of external charging devices;

FIG. 4 is a flowchart showing processing procedures of pre-cooling processing in a modification; and

FIG. 5 is a diagram showing temperature maps.

### DETAILED DESCRIPTION OF EMBODIMENTS

An embodiment and a modification of the present disclosure will be described in detail below with reference to the drawings. Note that same or corresponding portions are denoted by the same signs throughout the drawings, and description thereof will not be repeated.

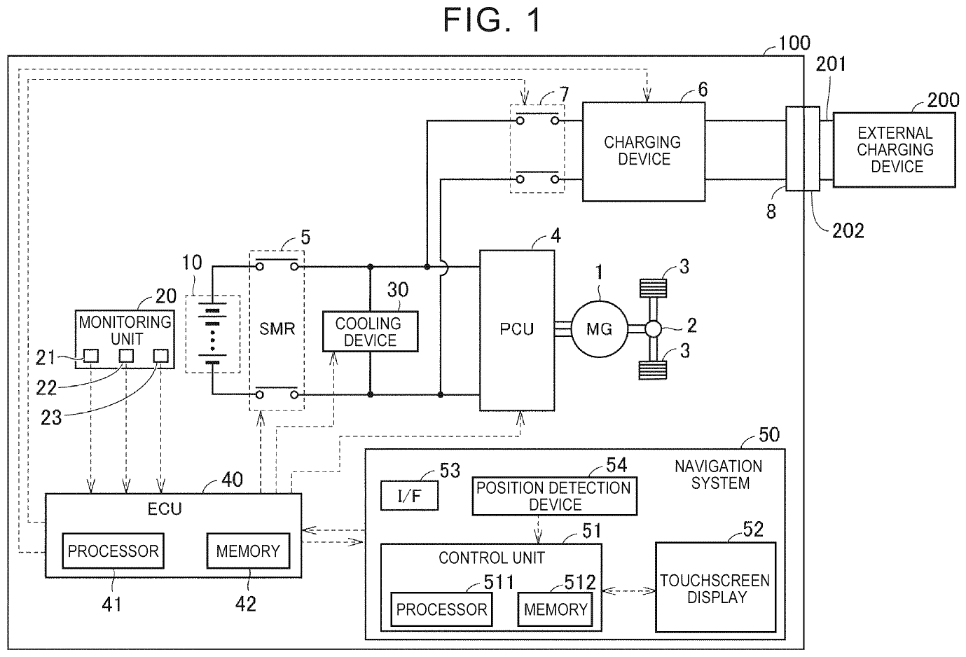

FIG. 1 is a diagram illustrating an example of a configuration of a vehicle according to an embodiment of the present disclosure. A vehicle 100 is a vehicle that can be connected to an external charging device 200 and be charged. The vehicle 100 is a battery electric vehicle, for example. It is sufficient for the vehicle 100 to be any vehicle that is configured to enable external charging, and may be a plug-in hybrid electric vehicle, for example. The external charging device 200 may be a rapid charger or a super-rapid charger. The external charging device 200 may be a normal charger.

The vehicle 100 includes a motor generator (MG) 1, power transmission gears 2, drive wheels 3, a power control unit (PCU) 4, a system main relay (SMR) 5, a charging device 6, a charging relay 7, an inlet 8, a battery 10, a monitoring unit 20, a cooling device 30, an electronic control unit (ECU) 40, and a navigation system 50. The vehicle 100 is configured to travel using the MG 1 as a drive source, and by supplying electric power that is stored in the battery 10 to the MG 1 via the PCU 4.

The MG 1 is, for example, a three-phase alternating current rotating electric machine, and has a function as an electric motor (motor) and a function as a generator. Output torque of the MG 1 is transmitted to the drive wheels 3 via the power transmission gears 2 configured including a reduction gear, a differential device, and so forth. When the vehicle 100 is braked, the MG 1 is driven by the drive wheels 3 and the MG 1 operates as a generator. The MG 1 can function as a braking device that performs regenerative braking to convert kinetic energy of the vehicle 100 into electric power. Regenerative electric power that is generated by regenerative braking of the MG 1 is stored in the battery 10.

The PCU 4 is a power conversion device that bidirectionally converts electric power between the MG 1 and the battery 10. The PCU 4 includes, for example, an inverter and a converter that operate based on control signals from the ECU 40. When the battery 10 is discharging, the converter steps up direct current electric power that is supplied from the battery 10 and performs supply thereof to the inverter, and the inverter converts the direct current electric power that is supplied from the converter into alternating current electric power to drive the MG 1. When charging the battery 10, the inverter converts the alternating current electric power that is generated by the MG 1 into direct current electric power and performs supply thereof to the converter, and the converter then steps down the direct current electric power that is supplied from the inverter to a voltage that is suitable for charging the battery 10 and performs supply thereof to the battery 10.

The SMR 5 is electrically connected between the PCU 4 and the battery 10. The SMR 5 operates in accordance with control signals from the ECU 40. When the SMR 5 is closed (i.e., in a conductive state) in accordance with control signals from the ECU 40, electric power can be exchanged between the PCU 4 and the battery 10. On the other hand, when the SMR 5 is opened (i.e., in an interrupted state) in accordance with control signals from the ECU 40, the electrical connection between the PCU 4 and the battery 10 is interrupted.

The charging device 6 generates direct current electric power that is capable of charging the battery 10, from electric power that is supplied from the inlet 8. The charging device 6 operates in accordance with control signals from the ECU 40. The charging device 6 may, for example, convert alternating current electric power that is supplied from the inlet 8 into direct current electric power, or may step up or step down voltage of the direct current electric power that is supplied from the inlet 8 to a voltage that is suitable for charging the battery 10.

The charging relay 7 is electrically connected between the charging device 6 and the battery 10. The charging relay 7 operates in accordance with control signals from the ECU 40. When the charging relay 7 is closed in accordance with control signals from the ECU 40, electric power can be supplied from the charging device 6 to the battery 10. On the other hand, when the charging relay 7 is opened in response to control signals from the ECU 40, the electrical connection between the charging device 6 and the battery 10 is interrupted.

The inlet 8 has a shape that enables a connector 202, provided at an end of a charging cable 201 that is connected to the external charging device 200, to be fit thereto. When the connector 202 is attached to the inlet 8, the vehicle 100 and the external charging device 200 are electrically connected to each other. This enables electric power to be supplied from the external charging device 200 to the battery 10 via the charging device 6.

The battery 10 corresponds to “power storage device” in the present disclosure. The battery 10 is a direct current power source that is capable of being charged and discharged. The battery 10 stores electric power that is supplied from the external charging device 200, and regenerative electric power that is generated by regenerative braking in the MG 1, as electric power for driving the MG 1 (i.e., electric power for travelling). The battery 10 is a battery module including a plurality of cells. Each cell may be a lithium-ion secondary battery or another type of secondary battery (for example, a nickel-metal hydride secondary battery). Also, each cell may be a solid-state battery.

The monitoring unit 20 includes a current sensor 21 that detects electric current of the battery 10, a voltage sensor 22 that detects voltage of the battery 10, and a temperature sensor 23 that detects temperature of the battery 10. The temperature of the battery 10 corresponds to “temperature of power storage device” according to the present disclosure. The monitoring unit 20 transmits detection results of the current sensor 21, the voltage sensor 22, and the temperature sensor 23, to the ECU 40.

The cooling device 30 operates in accordance with control signals from the ECU 40, to cool the battery 10. The cooling device 30 is of a liquid cooling type. The cooling device 30 uses, for example, coolant as a refrigerant, and cools the battery 10 by using a water pump to circulate the coolant through refrigerant piping that is provided in a battery case that houses the battery 10, and to exchange heat with the battery 10. The cooling device 30 may be a fan.

The ECU 40 controls the PCU 4, the SMR 5, the charging device 6, the charging relay 7, the cooling device 30, and the navigation system 50. The ECU 40 corresponds to “control device” in the present disclosure. The ECU 40 includes a processor 41 and memory 42. The processor 41 includes processing circuits such as a central processing unit (CPU), a microprocessor unit (MPU), or the like. The memory 42 includes volatile storage devices such as dynamic random access memory (DRAM), static random access memory (SRAM), and so forth, and non-volatile storage devices (storage) such as a hard disk drive (HDD), a solid state drive (SSD), flash memory, and so forth. The memory 42 stores system programs including an operating system (OS), programs for controlling operation of the vehicle 100, and various types of maps (e.g., a state of charge (SOC)-open circuit voltage (OCV) curve). The SOC-OCV curve indicates the SOC of the battery 10 corresponding to the voltage that is detected by the voltage sensor 22. The processor 41 realizes various types of processing by reading out system programs and other programs, which are then loaded to the memory 42, and executed by the processor 41. As an example, the processor 41 identifies, from the SOC-OCV curve that is stored in the memory 42, the SOC corresponding to voltage that is detected by the voltage sensor 22 when the vehicle 100 is started, and stores the identified SOC in the memory 42 as the SOC of the battery 10 when the vehicle 100 is started. As another example, the processor 41 executes pre-cooling processing, which will be described later.

Note that while only one processor is illustrated in FIG. 1, the vehicle 100 may include a plurality of processors. In the present specification, the term “processor” is not limited to a processor in the narrow sense that executes processing in a stored-program arrangement, but may include hardwired circuits such as an application specific integrated circuit (ASIC), a field-programmable gate array (FPGA), and so forth. Accordingly, the term “processor” can be interpreted as a circuit (circuitry) or a processing circuit (processing circuitry) of which operations are defined in advance by computer readable code and/or hardwired circuits.

The navigation system 50 includes a control unit 51, a touchscreen display 52, an interface 53, and a position detection device 54.

The control unit 51 includes a processor 511 and memory 512. The control unit 51 is configured to be capable of communication with the ECU 40 via the interface 53. The processor 511 includes processing circuits such as a CPU, an MPU, or the like. The memory 512 includes volatile storage devices such as DRAM, SRAM, or the like, and non-volatile storage devices such as an HDD, an SSD, a flash memory, or the like. The memory 512 stores system programs including the OS, programs for controlling operation of the navigation system 50, map information, and the maximum current of the external charging device 200. The processor 511 realizes various types of processing by reading out system programs and other programs, which are then loaded to the memory 512, and executed by the processor 511.

The touchscreen display 52 includes an input device (touch panel) that accepts input from a user. The control unit 51 receives signals that are generated by user operations on the input device. The user can input instructions or requests of the user to the input device. As an example, when the user performs an operation on the input device to set a destination of the vehicle 100, the control unit 51 sets the destination that is input by this operation as the destination of the vehicle 100. This sets the destination of the vehicle 100 in the navigation system 50. Various types of switches, various types of pointing devices, keyboards, or the like, may be used as the input device, instead of or in addition to a touch panel.

The touchscreen display 52 includes a display unit that displays various types of information. Information regarding images that are displayed on the touchscreen display 52 is transmitted from the ECU 40 to the navigation system 50 via the interface 53. The control unit 51 executes display control of the touchscreen display 52, such that various types of information (e.g., map information, guidance information) are displayed on the display unit of the touchscreen display 52.

The position detection device 54 detects the position of the vehicle 100 using, for example, a Global Positioning System (GPS) satellite or a wireless local area network (LAN). The position detection device 54 transmits, to the control unit 51, information regarding position detection results of the vehicle 100.

The control unit 51 identifies a travel routes on a map, from a current position of the vehicle 100 to a destination that is set by a user operation, guides the vehicle 100 traveling along the driving route to the destination, and so forth. The control unit 51 calculates the estimated time at which the vehicle 100 will arrive at the destination (hereinafter referred to as “estimated arrival time”), and notifies the ECU 40 of the estimated arrival time. The control unit 51 notifies the ECU 40 of the maximum current of the external charging device 200.

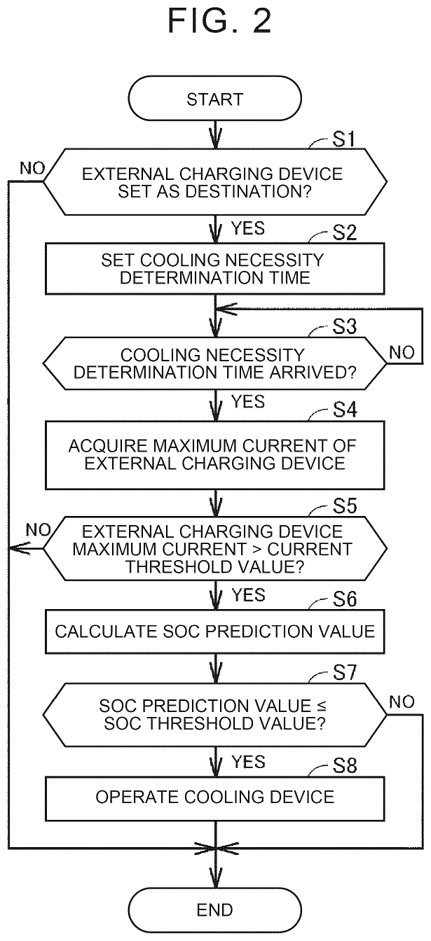

FIG. 2 is a flowchart showing processing procedures of pre-cooling processing that is executed by the ECU 40. The pre-cooling processing is started, triggered by the user setting a destination of the vehicle 100 in the navigation system 50, for example. Each step of the pre-cooling processing is realized by software processing by the ECU 40, but may also be realized by hardware (electrical circuitry) that is disposed within the ECU 40. Hereinafter, “step” will be abbreviated to “S”.

In S1, the processor 41 determines, based on a notification from the navigation system 50, whether the external charging device 200 has been set in the navigation system 50 as the destination of the vehicle 100. When the external charging device 200 has been set as the destination of the vehicle 100 (YES in S1), the processor 41 advances the processing to S2. When the external charging device 200 is not set as the destination of the vehicle 100 (NO in S1), the processor 41 ends the pre-cooling processing without operating the cooling device 30.

In S2, the processor 41 acquires the estimated arrival time of the vehicle 100 from the navigation system 50, and sets a time that is a predetermined amount of time (for example, one hour) before the estimated arrival time, as a cooling necessity determination time. The predetermined time is determined based on cooling capacity of the cooling device 30, such that when the cooling device 30 is operated by the pre-cooling processing, the battery 10 can be cooled down before the vehicle 100 reaches the destination. Next, in S3, the processor 41 determines whether the cooling necessity determination time has arrived. When the cooling necessity determination time has arrived (YES in S3), the processor 41 advances the processing to S4. When the cooling necessity determination time has not arrived (NO in S3), the processor 41 repeats S3.

In S4, the processor 41 acquires the maximum current of the external charging device 200 from the navigation system 50. The maximum currents for various types of external charging devices are registered in the navigation system 50, in advance. Next, in S5, the processor 41 determines whether the maximum current of the external charging device 200 exceeds a current threshold value (e.g., 250 amperes). The current threshold value is determined based on, for example, the maximum current value of an external charging device that supports rapid charging. When the maximum current of the external charging device 200 exceeds the current threshold value (YES in S5), the processor 41 advances the processing to S6. When the maximum current of the external charging device 200 does not exceed the current threshold value (NO in S5), the processor 41 ends the pre-cooling processing without operating the cooling device 30.

In S6, the processor 41 calculates, based on the navigation information from the navigation system 50, a prediction value that is predicted regarding what the SOC of the battery 10 will be when the vehicle 100 reaches the destination (hereinafter referred to as “SOC prediction value”). The navigation information includes, for example, distance from the current position of the vehicle 100 to the destination, the estimated arrival time, speed limits from the current position of the vehicle 100 to the destination, and so forth.

The SOC prediction value is calculated, for example, as follows. First, the processor 41 calculates the amount of change in the SOC of the battery 10 from when the vehicle 100 was started to the present time (hereinafter referred to as the “first amount of change”) by a current value integration method. Next, based on the navigation information, the processor 41 calculates an amount of change that is predicted as the amount of change of the SOC of the battery 10, from the present time until the vehicle 100 reaching the destination (hereinafter referred to as the “second amount of change”). Next, the processor 41 adds the first amount of change and the second amount of change to the SOC of the battery 10 at the time when the vehicle 100 was started, and takes this value as being an SOC prediction value.

Next, in S7, the processor 41 determines whether the SOC prediction value is equal to or less than an SOC threshold value (e.g., 30%). The SOC threshold value corresponds to “first SOC threshold value” in the present disclosure. When the SOC prediction value is equal to or less than the SOC threshold value (YES in S7), the processor 41 advances the processing to S8. When the SOC prediction value exceeds the SOC threshold value (NO in S7), the processor 41 ends the pre-cooling processing without operating the cooling device 30. In S8, the processor 41 operates the cooling device 30, and ends the pre-cooling processing. In S8, the cooling device 30 is operated before the vehicle 100 reaches the destination, and the battery 10 is cooled by the operation of the cooling device 30.

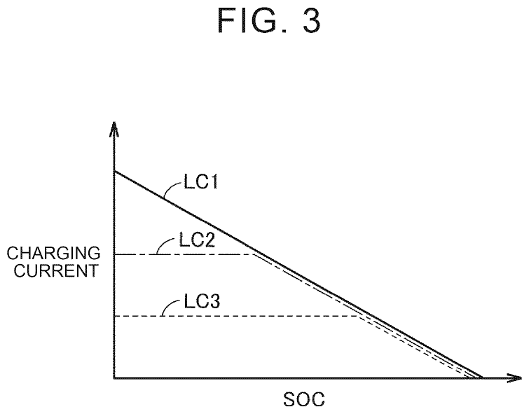

FIG. 3 is a graph showing a relation between the SOC of the battery 10 and the charging current flowing through the battery 10, for each maximum current of the external charging devices. A line LC1 indicates a relation between the SOC of the battery 10 and the charging current flowing through the battery 10 when the maximum current of the external charging device is 400 amperes. A line LC2 indicates a relation between the SOC of the battery 10 and the charging current flowing through the battery 10 when the maximum current of the external charging device is 250 amperes. A line LC3 indicates a relation between the SOC of the battery 10 and the charging current flowing through the battery 10 when the maximum current of the external charging device is 125 amperes.

As indicated by the line LC1, when the maximum current of the external charging device is great and also the SOC of the battery 10 is low, the charging current flowing through the battery 10 becomes great. When the charging current flowing through the battery 10 is great, the amount of heat that is generated by the battery 10 increases, causing the battery 10 to become hot. When the battery 10 becomes hot, the external charging device limits the charging current in order to suppress deterioration of the battery 10, and accordingly the charging time becomes prolonged.

In contrast, as shown by the line LC2 and the line LC3, when the maximum current of the external charging device is small, the charging current flowing through the battery 10 is small regardless of the SOC of the battery 10. Also, as indicated by the line LC1, when the maximum current of the external charging device is great but the SOC of the battery 10 is high, the charging current flowing through the battery 10 is small. When the charging current flowing through the battery 10 is small, the battery 10 does not readily become hot, and accordingly the charging current is unlikely to be limited.

Thus, in the present embodiment, when the external charging device 200 is set as the destination in the navigation system 50, and also when the maximum current of the external charging device 200 exceeds the current threshold value and also the SOC prediction value is equal to or less than the SOC threshold value, the ECU 40 operates the cooling device 30 before the vehicle 100 reaches the destination. When the maximum current of the external charging device 200 exceeds the current threshold value and also the SOC prediction value is equal to or lower than the SOC threshold value, the battery 10 is expected to become hot to the extent that the charging current will be limited when the battery 10 is charged. According to the present embodiment, in such a case, the cooling device 30 operates before the vehicle 100 reaches the destination, and accordingly the battery 10 does not become hot to the extent that the charging current is limited when the battery 10 is being charged. Thus, according to the vehicle 100 of the present embodiment, the charging current is not limited, whereby the battery 10 is charged with a great current, and hence, the charging time of the battery 10 is shortened.

Also, in the present embodiment, when the maximum current of the external charging device 200 does not exceed the current threshold value, the ECU 40 does not operate the cooling device 30 before the vehicle reaches the destination. When the maximum current of the external charging device 200 does not exceed the current threshold value, the battery 10 does not become hot to the extent that the charging current is limited when the battery 10 is being charged. If the cooling device 30 were to be operated in such a case, the temperature of the battery 10 might become lower than a temperature that is suitable for charging, and the charging time might become prolonged. Furthermore, if the cooling device 30 were to be operated in such a case, electric mileage would become poor due to unnecessary cooling. Thus, according to the vehicle 100 of the present embodiment, the charging time of the battery 10 is suppressed from becoming prolonged, and also the electric mileage is suppressed from becoming poor.

### Modifications

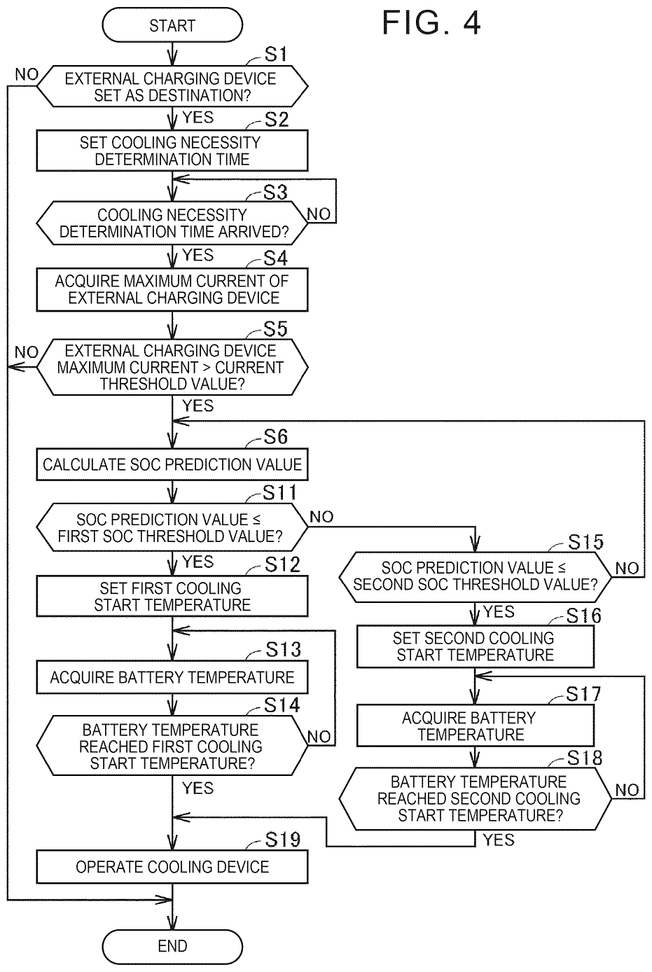

The processor 41 may execute the processing shown in FIG. 4 as the pre-cooling processing, instead of the processing shown in FIG. 2. FIG. 4 is a flowchart showing processing procedures of pre-cooling processing in a modification. Processing shown in FIG. 4 that is the same as the processing shown in FIG. 2 is denoted by the same step number, and will not be described repeatedly.

Following S6, the processor 41 advances the processing to S11. In S11, the processor 41 determines whether the SOC prediction value is equal to or less than the first SOC threshold value (e.g., 30%). When the SOC prediction value is equal to or less than the first SOC threshold value (YES in S11), the processor 41 advances the processing to S12. When the SOC prediction value exceeds the first SOC threshold value (NO in S11), the processor 41 advances the processing to S15.

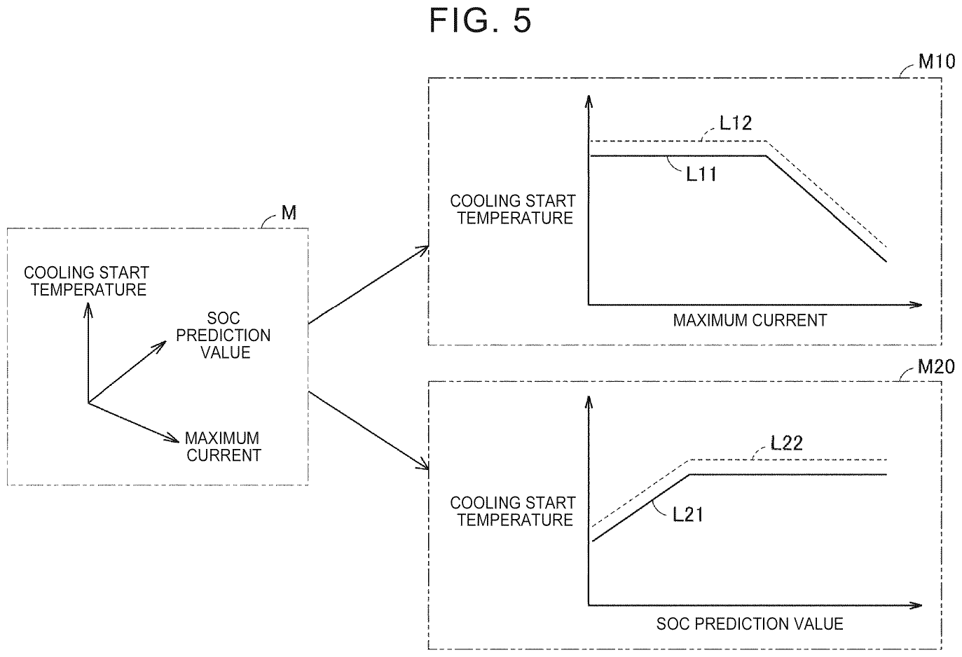

In S12, the processor 41 sets a first cooling start temperature based on a temperature map M that will be described with reference to FIG. 5. Next, in S13, the processor 41 acquires the temperature of the battery 10 from the temperature sensor 23. Next, in S14, the processor 41 determines whether the temperature of the battery 10 has reached the first cooling start temperature. When the temperature of the battery 10 has reached the first cooling start temperature (YES in S14), the processor 41 advances the processing to S19. When the temperature of the battery 10 has not reached the first cooling start temperature (NO in S14), the processor 41 returns the processing to S13.

In S15, the processor 41 determines whether the SOC prediction value is equal to or less than a second SOC threshold value. The second SOC threshold value is a value (e.g., 35%) that is higher than the first SOC threshold value. When the SOC prediction value is equal to or less than the second SOC threshold value (YES in S15), the processor 41 advances the processing to S16. When the SOC prediction value exceeds the second SOC threshold value (NO in S15), the processor 41 returns the processing to S6. When the processing returns to S6, the processor 41 recalculates the SOC prediction value, and compares the recalculated prediction value with the first SOC threshold value or the second SOC threshold value to determine whether the cooling device 30 needs to be operated (i.e., whether the battery 10 needs to be cooled).

In S16, the processor 41 sets a second cooling start temperature based on the temperature map M that will be described with reference to FIG. 5. Next, in S17, the processor 41 acquires the temperature of the battery 10 from the temperature sensor 23. Next, in S18, the processor 41 determines whether the temperature of the battery 10 has reached the second cooling start temperature. When the temperature of the battery 10 has reached the second cooling start temperature (YES in S18), the processor 41 advances the processing to S19. When the temperature of the battery 10 has not reached the second cooling start temperature (NO in S18), the processor 41 returns the processing to S17. In S19, the processor 41 operates the cooling device 30, and ends the pre-cooling processing. In S19, the cooling device 30 is operated before the vehicle 100 reaches the destination, and the battery 10 is cooled by the operation of the cooling device 30.

FIG. 5 is a diagram showing temperature maps. The temperature map M is a three-dimensional graph showing a relation among the maximum current of the external charging device 200, the SOC prediction value, and the cooling start temperatures (first cooling start temperature and second cooling start temperature). The temperature map M is stored in the memory 42 (see FIG. 1). The temperature map M includes a map M10 and a map M20.

The map M10 is a two-dimensional graph that is extracted from the temperature map M, and shows a relation between the maximum current of the external charging device 200 and the cooling start temperature when the SOC prediction value is constant. The map M10 includes a line L11 and a line L12. The line L11 indicates a relation between the maximum current of the external charging device 200 and the first cooling start temperature when the SOC prediction value is constant. The line L12 indicates a relation between the maximum current of the external charging device 200 and the second cooling start temperature when the SOC prediction value is constant.

The map M20 is a two-dimensional graph that is extracted from the temperature map M, and shows a relation between the SOC prediction value and the cooling start temperature when the maximum current of the external charging device 200 is constant. The map M20 includes a line L21 and a line L22. The line L21 indicates a relation between the SOC prediction value and the first cooling start temperature when the maximum current of the external charging device 200 is constant. The line L22 indicates a relation between the SOC prediction value and the second cooling start temperature when the maximum current of the external charging device 200 is constant.

As shown in the map M10, when the SOC prediction value is constant, the greater the maximum current of the external charging device 200 is, the lower the cooling start temperature that is associated therewith is. As shown in the map M20, when the maximum current of the external charging device 200 is constant, the lower the SOC prediction value is, the lower the cooling start temperature that is associated therewith is. That is to say, in the temperature map M, the greater the maximum current of the external charging device 200 is, and also, the lower the SOC prediction value is, the lower the cooling start temperature that is associated therewith is.

Also, in the temperature map M, a temperature that is higher than the first cooling start temperature is associated with the second cooling start temperature. The processor 41 sets this first cooling start temperature such that the greater the maximum current of the external charging device 200 is and also the lower the SOC prediction value is, the lower the first cooling start temperature is set to be. The processor 41 sets this second cooling start temperature such that the greater the maximum current of the external charging device 200 is and also the lower the SOC prediction value is, the lower the second cooling start temperature is set to be.

Also, in the temperature map M, the first cooling start temperature and the second cooling start temperature are each determined based on life requirement of the battery 10. The processor 41 sets each of the first cooling start temperature and the second cooling start temperature based on the life requirement of the battery 10. The life requirement of the battery 10 is, for example, a temperature condition of the battery 10 that causes performance degradation of the battery 10.

Thus, according to the modification, in a case in which the external charging device 200 is set as the destination in the navigation system 50, when the maximum current of the external charging device 200 exceeds the current threshold value and also the SOC prediction value is equal to or lower than the first SOC threshold value, the ECU 40 sets the first cooling start temperature such that the greater the maximum current of the external charging device 200 is and also the lower the SOC prediction value is, the lower the first cooling start temperature is set to be, and further operates the cooling device 30 in accordance with the temperature of the battery 10 reaching the first cooling start temperature. That is to say, when it is expected that the battery 10 will become hot to the extent that the charging current will be limited when the battery 10 is being charged, the cooling device 30 operates in accordance with the temperature of the battery 10 reaching the first cooling start temperature, before the vehicle 100 reaches the destination. Thus, according to the modification, the charging current is not limited, and accordingly the charging time of the battery 10 is shortened. Also, according to the modification, the cooling device 30 is not operated until the temperature of the battery 10 reaches the first cooling start temperature, whereby the cooling device 30 does not operate earlier than necessary, and accordingly the electric mileage is suppressed from becoming poor.

Also, according to the modification, in a case in which the external charging device 200 is set as the destination in the navigation system 50, when the maximum current of the external charging device 200 exceeds the current threshold value and also the SOC prediction value exceeds the first SOC threshold value but is equal to or lower than the second SOC threshold value, the ECU 40 sets the second cooling start temperature such that the greater the maximum current of the external charging device 200 is and also the lower the SOC prediction value is, the lower the second cooling start temperature is set to be, and further operates the cooling device 30 in accordance with the temperature of the battery 10 reaching the second cooling start temperature. Thus, according to the modification, a situation in which the cooling device 30 does not operate due to slight error in the SOC prediction value is circumvented, and thus the charging time of the battery 10 can be shortened more reliably.

Furthermore, according to the modification, in a case in which the external charging device 200 is set as the destination in the navigation system 50, when the maximum current of the external charging device 200 exceeds the current threshold value and also the SOC prediction value exceeds the second SOC threshold value, the ECU 40 recalculates the SOC prediction value and compares the recalculated prediction value with the first SOC threshold value to determine whether operation of the cooling device 30 is necessary. Thus, according to the modification, even when the SOC prediction value becomes lower than an initially predicted value due to traffic congestion or the like before the vehicle reaches the destination, the charging time of the battery 10 can be shortened.

Also, according to the modification, the first cooling start temperature and the second cooling start temperature are each set based on the life requirement of the battery 10, and accordingly deterioration of the battery 10 is suppressed.

The embodiment disclosed herein should be considered to be exemplary in all respects and not restrictive. The scope of the present disclosure is set forth in the claims and not the above description, and is intended to encompass all modifications within the meaning and scope equivalent to those of the claims.

What is claimed is:

1. A vehicle that is chargeable by connection to an external charging device, the vehicle comprising:
a navigation system in which a destination of the vehicle is set;
a power storage device that stores electric power that is supplied from the external charging device;
a cooling device that cools the power storage device; and
a control device that controls the cooling device, wherein
when the external charging device is set as the destination in the navigation system, the control device
acquires a maximum current of the external charging device from the navigation system,
calculates a prediction value of what a state of charge (SOC) of the power storage device will be when the vehicle reaches the destination, based on navigation information from the navigation system, and
when the maximum current exceeds a current threshold value and also the prediction value is equal to or less than a first SOC threshold value, operates the cooling device before the vehicle reaches the destination.

2. The vehicle according to claim 1, wherein, when the maximum current does not exceed the current threshold value, the control device does not operate the cooling device before the vehicle reaches the destination.

3. The vehicle according to claim 2, further comprising a temperature sensor that detects a temperature of the power storage device, wherein,
in a case in which the external charging device is set as the destination in the navigation system, when the maximum current exceeds the current threshold value and also the prediction value is equal to or less than the first SOC threshold value, the control device
sets a first cooling start temperature such that the higher the maximum current is and also the lower the prediction value is, the lower the first cooling start temperature is set to be, and
operates the cooling device in accordance with the temperature reaching the first cooling start temperature.

4. The vehicle according to claim 3, wherein,
when the external charging device is set as the destination in the navigation system, and also the maximum current exceeds the current threshold value, the control device
sets the first cooling start temperature such that, when the prediction value is equal to or lower than the first SOC threshold value, the greater the maximum current is and also the lower the predicted value is, the lower the first cooling start temperature is set to be, and operates the cooling device in accordance with the temperature reaching the first cooling start temperature,
sets a second cooling start temperature such that, when the prediction value exceeds the first SOC threshold value but is equal to or lower than a second SOC threshold value that is higher than the first SOC threshold value, the greater the maximum current is and also the lower the prediction value is, the lower the second cooling start temperature that is higher than the first cooling start temperature is set to be, and operates the cooling device in accordance with the temperature reaching the second cooling start temperature, and
recalculates the prediction value when the prediction value exceeds the second SOC threshold value, and the prediction value that is recalculated is compared with the first SOC threshold value or the second SOC threshold value to determine whether operation of the cooling device is necessary.

5. The vehicle according to claim 4, wherein the control device sets each of the first cooling start temperature and the second cooling start temperature based on a life requirement of the power storage device.
